(19) United States
(12) Patent Application Publication
(10) Pub. No.: US 2003/0232146 A1
(43) Pub. Date: Dec. 18, 2003

(54) Method of forming zinc coating

(76) Inventors: Takanobu Iwade, Okazaki-City (JP); Masato Aizawa, Okazaki-City (JP); Hiroshi Sumiya, Hekinan-City (JP); Seiji Amakusa, Kasugai-City (JP); Hiroshi Kawaguchi, Kariya-City (JP)

Correspondence Address: HARNESS, DICKEY & PIERCE, P.L.C., P.O. BOX 828, BLOOMFIELD HILLS, MI, 48303, US

(21) Appl. No.: 10/460,980

(22) Filed: Jun. 13, 2003

(30) Foreign Application Priority Data
Jun. 14, 2002 (JP) 2002-174182

(51) Int. Cl. B05D 1/36

(52) U.S. Cl. 427/405; 427/406

(57) ABSTRACT

The present invention provides a method of forming a zinc coating that can form a chromate film, capable of withstanding hydrogen embrittlement-preventive treatment, by optimizing the conditions under which chromating is conducted.

The method of forming a zinc coating comprises galvanizing the surface of a work composed of an iron-based material, subjecting the surface of the zinc plating layer to trivalent chromate treatment, and subjecting the work to hydrogen embrittlement-preventive treatment. When the work having been subjected to trivalent chromate treatment is taken out of a trivalent chromating bath and is to be dried, the work is not dried at a high temperature but is dried at a temperature of up to 40° C. According to the treatment procedure, the trivalent chromate treatment can form a chromate film capable of withstanding the hydrogen embrittlement-preventive treatment. Accordingly, the work having been galvanized and subjected to trivalent chromate treatment can be subjected to a hydrogen embrittlement-preventive treatment. As a result, a series of plating and chromating steps can be carried out with are plating apparatus, and the production cost can be reduced by reducing the number of the production steps.

### BACKGROUND OF THE INVENTION

1. Field of the Invention

The present invention relates to a method, of forming a zinc coating, comprising the step of forming a zinc coating on the surface of a work composed of an iron-based material.

2. Description of the Related Art

Galvanizing has heretofore been conducted as a surface treatment, intended for rust and corrosion prevention, on iron products. Galvanizing is extremely effective as a rust preventive plating on iron. However, because a zinc plating layer forms the so-called white rust when exposed to the air, the zinc plating layer surface is usually chromated in order to maintain the corrosion resistance of the iron-based material over a long period of time.

Moreover, when an iron-based material is galvanized, the material is subjected to a hydrogen embrittlement-preventive treatment in which the material is heated to a high temperatures (at least 180° C.) in a baking furnace for a long period (at least one hour) in order to drive out any hydrogen in the grain boundaries of the material.

Plating and chromating can be conducted in a series of steps in a conventional plating apparatus. Accordingly, if a hydrogen embrittlement-preventive treatment could be conducted after chromating, formation of a zinc coating on the work can be achieved by two steps: a plating apparatus (plating→chromating); and a hydrogen embrittlement-preventive treatment. However, when hydrogen embrittlement-preventive treatment is conducted after chromating, cracks are formed in the chromate film to deteriorate the corrosion resistance of the galvanized material due to the low heat resistance of the chromate film, and a quality requirement cannot be satisfied.

Accordingly, in the present situation, as shown in FIG. 4, formation of a zinc coating on the work is carried out by the following three steps: plating (pretreatment-plating-drying); dehydrogenation (hydrogen embrittlement-preventive treatment); and chromating (etching-chromating-drying). The process therefore is expensive.

The present invention has been achieved by taking the above circumstances into consideration. An object of the present invention is to provide a method, of forming a zinc coating, that can form a chromate film, capable of withstanding hydrogen embrittlement-preventive treatment, by optimizing the conditions under which chromating is conducted.

### SUMMARY OF THE INVENTION

According to a first aspect of the invention, a method of forming a zinc coating in the present invention comprises galvanizing the surface of a work composed of an iron-based material, subjecting the surface of the zinc plating layer to trivalent chromate treatment, and subjecting the work to hydrogen embrittlement-preventive treatment.

Because the chromate film (containing no hexavalent chromium ions) formed by a trivalent chromate treatment shows improved heat resistance, in comparison with a chromate film containing hexavalent chromium ions in a large amount, a chromate film capable of withstanding hydrogen embrittlement-preventive treatment can be formed by a trivalent chromate treatment. Because a hydrogen embrittlement-preventive treatment can be conducted after the above treatment, plating and chromating can be conducted in a series of steps, and the production cost can be reduced by reducing the number of the processing steps (from three to two steps).

According to a second aspect of the invention, in the method of forming a zinc coating according to the first aspect, in the drying step for removing moisture from the work after the trivalent chromate treatment, the work taken out of a chromating bath is dried at temperatures of up to 40° C.

Because a chromate film directly after its formation is very brittle, the film instantaneously lose its moisture when dried at high temperature, cracks are sometimes formed in the specially formed film, and the film sometimes exfoliates (falls off). In contrast to the drying at high temperature, drying the film at temperatures of up to 40° C. can stabilize the film, and a chromate film capable of withstanding a hydrogen embrittlement-preventive treatment can be obtained.

### BRIEF DESCRIPTION OF THE DRAWINGS

FIG. 1 is a flow chart showing the processing steps in the method of forming a zinc coating (present example).

FIG. 2 is a schematic view showing the structure of the coating.

FIG. 3 is a view showing the results of evaluation tests for the salt spray corrosion resistance of samples.

FIG. 4 is a flow chart showing the processing steps in the method of forming a zinc coating.

Next, the embodiment of the present invention will be explained by making reference to the figures.

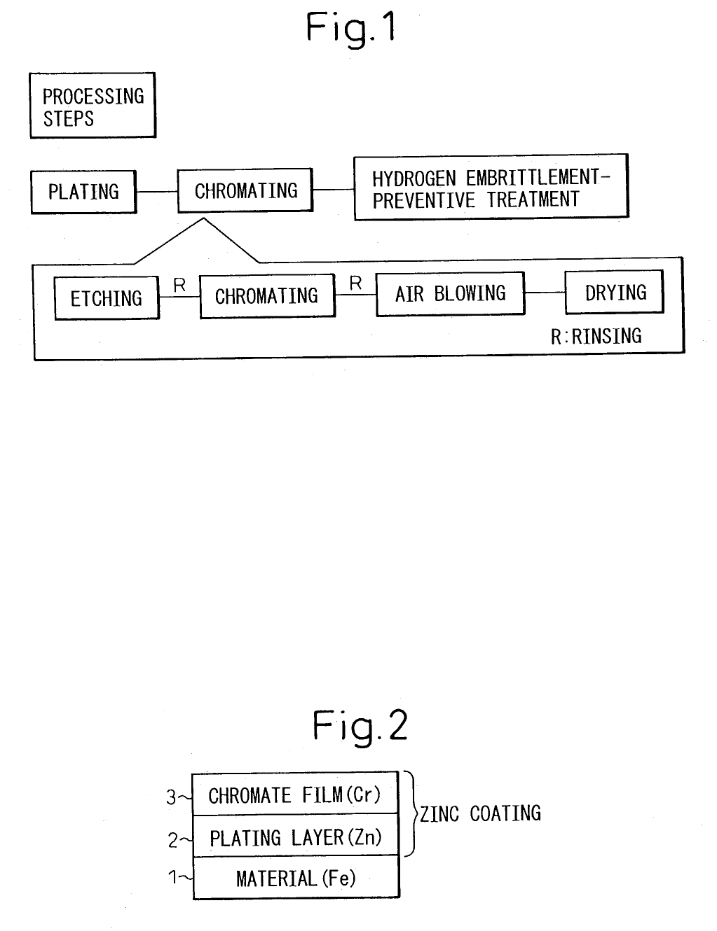

FIG. 1 is a flow chart showing the processing steps in the method of forming a zinc coating, and FIG. 2 is a schematic view sowing the structure of the coating.

As shown in FIG. 2, the present example relates to a method of forming a zinc coating on the surface of a work 1 composed of an iron-based material. The work 1 is successively subjected to plating, chromating and hydrogen embrittlement-preventive treatment. In addition, the zinc coating in the present invention designates a zinc plating layer 2+chromate film 3.

Plating and chromating are carried out by any of the following types: a hanger type (rack type); a barrel type (rotation type); and a cage type.

The plating comprises pretreating the work 1 to remove smears such as fats and foils and rust, electrogalvanizing the work 1 by immersing it in a plating bath, and rinsing the plated work 1 after taking it out of the plating bath.

Chromating is carried out by etching (immersing the galvanized work 1 in nitric acid for a few seconds to activate the surface), and immersing the rinsed work 1 in a trivalent chromate bath. The thickness of a chromate film 3 is determined by the treatment conditions such as a treatment time, a bath temperature and a concentration. When the film is thin, the corrosion resistance is insufficient. Conversely, when the film is too thick, exfoliation, or crack formation in the film, takes place. It is therefore important to determine the treatment conditions under which the corrosion resistance becomes sufficient and neither exfoliation nor crack formation of the film takes place. However, because commercially available trivalent chromate solutions have film reaction (film formation) rates different from each other, the most suitable treatment condition of each commercially available chemical must be determined.

Next, the work 1 is taken out of the trivalent chromate bath, rinsed (after air blowing when a hanger type or a cage type is used), and dried.

Even when the thickness of the chromate film 3 is optimized as much as possible during the above treatment, defects are formed in the film if the drying conditions are not suitable, and the defects spread during the hydrogen embrittlement-preventive treatment to deteriorate the corrosion resistance of the work 1. The formation of defects must therefore be suppressed during drying. The drying method does not include drying at a high temperature at which the work 1 is heated but does include drying at temperatures of up to 40° C., natural drying at room temperature, vacuum drying, air blowing or the like.

For example, the film may be dried at the ambient temperature (0°-40° C.), in which no additional equipment, such as a cooling means, is used, in order to stabilize the film.

The hydrogen embrittlement-preventive treatment is subsequently conducted.

The hydrogen embrittlement-preventive treatment is conducted by heating the work 1 to high temperatures (at least 180° C.) in a baking furnace.

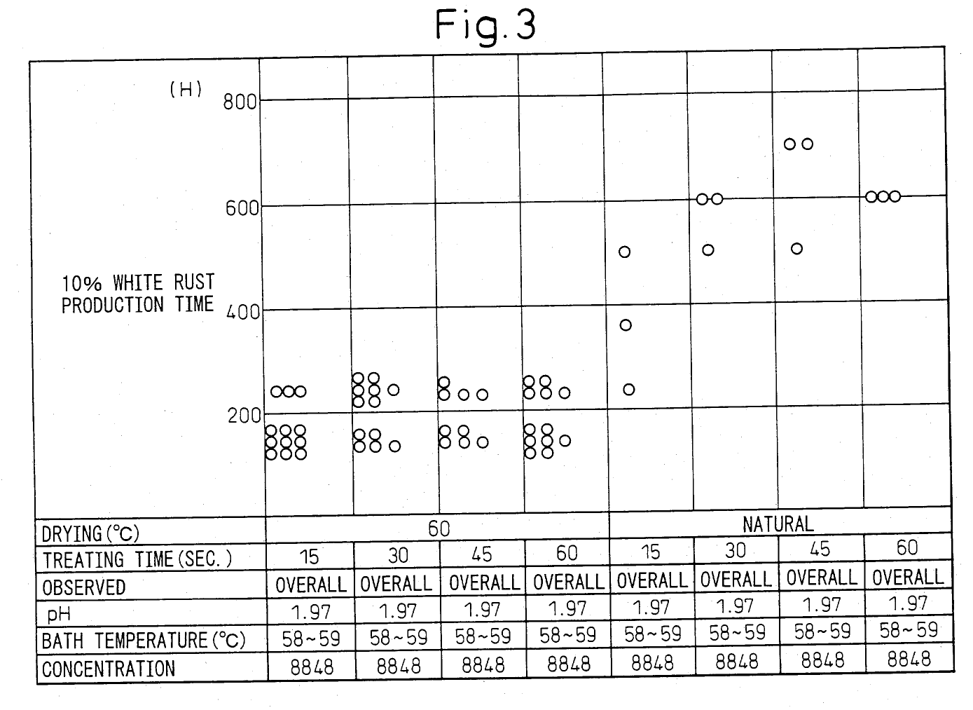

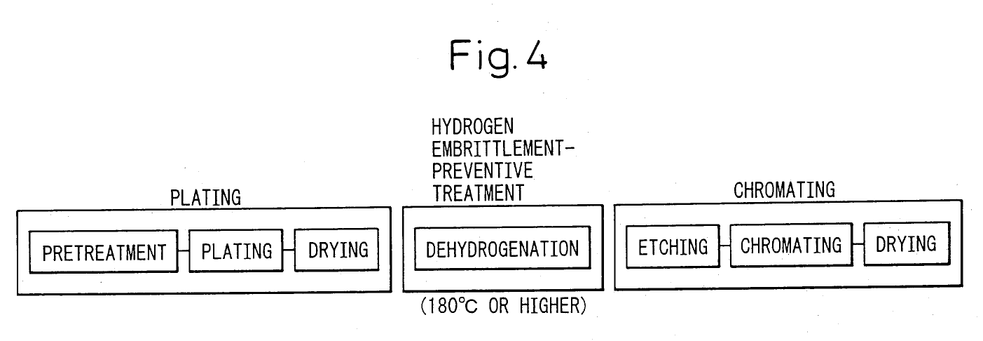

The works 1 having been subjected to trivalent chromate treatment were subjected to either high temperature drying (at 60° C.) or natural drying. The works 1 were then subjected to the hydrogen embrittlement-preventive treatment and to evaluation tests for salt spray corrosion resistance. FIG. 3 shows the results.

In the evaluation tests, those works 1 that were subjected to natural drying gave good results (good corrosion resistance) in comparison with those that were subjected to high temperature drying. However, because the corrosion resistance of the works 1 having been subjected to natural drying varies depending on the treatment time, establishment of the optimum treatment conditions (the thickness of a chromate film 3 in particular) is desired.

Because a chromate film 3 capable of withstanding a hydrogen embrittlement-preventive treatment can be formed on a work 1 by a trivalent chromate treatment according to the method of the present example, the work 1 can be galvanized, and then subjected to trivalent chromate treatment and then to a hydrogen embrittlement-preventive treatment. As a result, a series of steps of plating and chromating can be conducted by are plating apparatus, and the production cost can be reduced by reducing the number of the processing steps (from the conventional three steps to the two steps of the present invention).

What is claimed is:

1. A method, of forming a zinc coating, comprising galvanizing the surface of a work composed of an iron-based material, subjecting the surface of the zinc plating layer to trivalent chromate treatment, and subjecting the work to a hydrogen embrittlement-preventive treatment.

2. The method of forming a zinc coating according to claim 1, wherein the hydrogen embrittlement-preventive treatment is conducted at temperatures of at least 180° C.

3. The method of forming a zinc coating according to claim 1, wherein, in the drying step for removing the moisture of the work after the trivalent chromate treatment, the work taken out of a chromating bath is dried at a temperature of up to 40° C.

4. The method of forming a zinc coating according to claim 3, wherein the drying is natural drying at room temperature.
